(19) United States
(12) Patent Application Publication
(10) Pub. No.: US 2015/0111509 A1
(43) Pub. Date: Apr. 23, 2015

(54) METHOD OF GENERATING GAIN COMBINATION OF PRE-AMPLIFIER IN TRANSMITTER OF MOBILE COMMUNICATION SYSTEM, METHOD OF CONTROLLING OUTPUT POWER OF TRANSMITTER OF MOBILE COMMUNICATION SYSTEM IN TRANSMITTER MANUFACTURING PROCESS, AND SYSTEM FOR CONTROLLING OUTPUT POWER OF TRANSMITTER OF MOBILE COMMUNICATION SYSTEM IN TRANSMITTER MANUFACTURING PROCESS

(71) Applicant: GCT Semiconductor, Inc., San Jose, CA (US)

(72) Inventors: Ei Ho LEE, Seoul (KR); Inho SONG, Seoul (KR)

(21) Appl. No.: 14/521,411

(22) Filed: Oct. 22, 2014

(30) Foreign Application Priority Data
Oct. 22, 2013 (KR) 10-2013-0125896

(51) Int. Cl. H04B 1/04; H04B 17/00

(52) U.S. Cl. CPC H04B 1/0475; H04B 17/0062; H04B 2001/0416
USPC 455/95

(57) ABSTRACT

A method of generating a gain combination of a pre-amplifier of a transmitter in a mobile communication system includes extracting respective pieces of gain combination information about pre-amplifiers of a plurality of sample transmitters among transmitters of the same group, arranging the respective pieces of gain combination information in order and measuring a difference between first output values with respect to adjacent pieces of gain combination information among the arranged pieces of gain combination information, deleting gain combination information that does not conform to linearity of the first output values and rearranging the respective pieces of gain combination information, measuring a difference between second output values with respect to adjacent pieces of gain combination information among the rearranged pieces of gain combination information, extracting second output value compensation parameters with respect to the respective pieces of gain combination information, and extracting common gain combination information about the respective pieces of gain combination information of the sample transmitters by use of the gain combination information, the difference between the second output values, and the second output value compensation parameters.

### CROSS-REFERENCE TO RELATED APPLICATION

This application claims the benefit of priority under 35 U.S.C. §119(a) to Korean Patent Application No. 10-2013-0125896, filed on Oct. 22, 2013 in the Korean Intellectual Property Office, the entire disclosure of which is incorporated herein by reference for all purposes.

### BACKGROUND

1. Field

The following description relates to a method of generating a gain combination used to control an output power of a transmitter of a mobile communication system in a transmitter manufacturing process, a method of controlling an output power by use of a gain combination, and a system for controlling an output power by use of a gain combination.

2. Discussion of Related Art

A mobile communication system typically has a strict regulation on the magnitude of transmit output power for communication between a base station and a mobile station. The regulation is provided to minimize neighbor interference while maximizing data throughput under the minimum power consumption conditions.

Accordingly, there is a need of verifying a dynamic range of an output power, the accuracy of an output power step, and a maximum output power at a transmission end that forms a communication system, and generally during a transmitter producing process, all transmitters need to be subject to a precise calibration regarding output power levels and control steps to satisfy defined communication system specifications. Such a calibration task performed during the manufacturing process is referred to as a factory calibration.

In general, a transmitter for a mobile communication system is provided with a plurality of analog pre-amplifiers to obtain a high gain, and is configured to generate a dynamic range of an output power and an output step by using a gain combination of each amplifier stage in consideration of noise characteristics and linearity of a transmitter.

In brief, the factory calibration on an output of a transmitter represents a process of measuring an output power strength corresponding to a gain combination allowed for an amplifier stage, and extracting information for error correction. In order to build a high performance mobile communication system, a wide dynamic range, a fine control step, and high accuracy are often used, resulting in an increase in the cost and time for the factory calibration.

Each apparatus, in principle, needs to be subject to an independent factory calibration to prevent accuracy degradation caused by variations of apparatuses. Accordingly, the expense incurred due to calibration time in the production process is increased, and the production cost is increased.

According to the technology to be described hereinafter, characteristics extracted from a predetermined sample are collectively applied to transmitters of the same type without performing an independent calibration on each transmitter.

### SUMMARY

In one general aspect, there is provided a method of generating a gain combination of a pre-amplifier in a transmitter of a mobile communication system, the method including: receiving general gain combination information about pre-amplifiers of transmitters of a same group; determining output value compensation parameters by applying the general gain combination information to each of a plurality of sample transmitters among the transmitters of the same group; and generating common gain combination information for the transmitters of the same group by use of the general gain combination information and an average of the output value compensation parameters of the respective sample transmitters.

The determining of the output value compensation parameters may include: measuring output values of pre-amplifiers of the sample transmitters by use of the general gain combination information; rearranging the output values of the sample transmitters in consideration of linearity of the output values; and finally determining output value compensation parameters for the sample transmitters.

In another general aspect, there is provided a method of controlling an output power in a process of manufacturing a transmitter of a mobile communication system, the method including: generating common gain combination information for a plurality of sample transmitters among transmitters of a same group by use of general gain combination information about the transmitters of the same group; and controlling output powers of the transmitters of the same group by use of the common gain combination information.

In yet another general aspect, there is provided a system for controlling an output power in a process of manufacturing a transmitter of a mobile communication system, the system including: a general gain combination storing unit configured to store general gain combination information about transmitters of a same group in consideration of noise characteristics and linearity of a transmitter of the mobile communication system; a common gain combination generator configured to generate common gain combination information for a plurality of sample transmitters among the transmitters of the same group by use of the general gain combination information; and an output power controlling unit configured to control output powers for the transmitters of the same group by use of the common gain combination information.

### BRIEF DESCRIPTION OF THE DRAWINGS

FIG. 1 is a flowchart illustrating an example of a method of generating a gain combination of pre-amplifiers for a transmitter of a mobile communication system, according to one exemplary embodiment.

FIG. 2 is a flowchart illustrating another example of a method of generating a gain combination of pre-amplifiers for a transmitter of a mobile communication system, according to one exemplary embodiment.

FIG. 3 is a diagram illustrating an example of a process of generating common gain combination information according to a gain combination extraction method shown in FIG. 2, according to one exemplary embodiment.

FIG. 4 is a flowchart illustrating an example of a method of controlling an output power of a transmitter in a process of manufacturing a transmitter of a mobile communication system, according to one exemplary embodiment.

FIG. 5 is a block diagram illustrating an example of a configuration of a system for controlling an output power in a process of manufacturing a transmitter of a mobile communication system, according to one exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

All terms (including technical and scientific terms) s) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

It will be understood that, although the terms first, second, etc, may be used herein to describe various elements, these elements should not be limited by these terms. Unless indicated otherwise, these terms are only used to distinguish one element from another. For example, a first circuit could be termed a second circuit, and, similarly, a second circuit could be termed a first circuit without departing from the teachings of the disclosure

It should also be noted that in performing a method or an operating method, processes of the method may occur out of noted order unlike otherwise mentioned. In other words, the respective processes may be executed in the same order as the noted order, may be executed substantially concurrently, or may be executed in the reverse order.

The techniques described below relate to a scheme of controlling an output power of a transmitter of a mobile communication system according to system standards in a process of producing the transmitter. The conventional scheme of individually performing a factory calibration on each transmitter ensures high accuracy, but increases production cost and time.

According to exemplary techniques described herein, gain combination information that is common to certain standard transmitters among transmitters are extracted, and the extracted common gain combination information is applied to all the transmitters, thereby remarkably reducing the cost and time required for factory calibration. In addition, the exemplary techniques described herein are provided to minimize errors in the gain combination information extracted from samples by considering variation in output powers among individual transmitters. According to these techniques, output powers and values are calculated with respect to gain combinations of a small number of samples, and such a calculation is performed by a separate computer device, so that the process of extracting common gain combination information does not exert a direct influence on the production cost.

According to the exemplary techniques described herein, a small number of standard transmitters are selected from transmitters belonging to the same product group, gain combination information with respect to the standard transmitter is extracted, and common gain combination information that may be applied to the same product group is generated. As such, a dynamic range for output power of a pre-amplifier is determined in a process of producing transmitters of the same product group. The factory calibration using the common gain combination information is performed by a factory calibration apparatus or a factory calibration system that is generally used in the conventional transmitter producing process. The transmitters of the same product group represent transmitters using the same chipset.

As described above, the controlling of output power of the transmitter is performed by use of a gain combination of a pre-amplifier stage included in the transmitter. Detailed descriptions of the general factory calibration process and the general process of controlling output powers by using gain combinations for pre-amplifiers will be omitted.

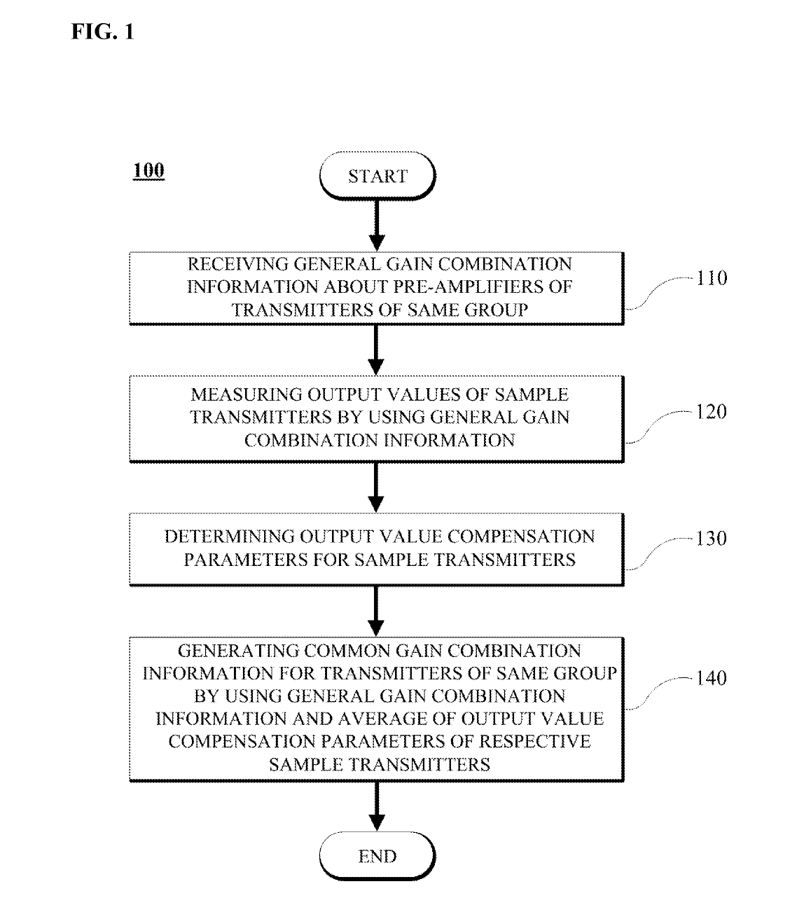

FIG. 1 is a flowchart illustrating an example of a method of generating a gain combination of pre-amplifiers for a transmitter of a mobile communication system. Each operation of FIG. 1 may be performed by a computer device provided in a factory or laboratory before output values are controlled in the transmitter manufacturing process.

The method of generating a gain combination of a pre-amplifier in a transmitter of a mobile communication system (100) may include respective pieces of receiving general gain combination information about pre-amplifiers of a plurality of sample transmitters among transmitters of the same group (110), measuring output values of the respective sample transmitters by use of the general gain combination information (120), determining output value compensation parameters for the respective sample transmitters (130), and generating common gain combination information for the transmitters of the same group by use of the general gain combination information and an average of the output value compensation parameters of the sample transmitters (140).

The transmitters of the same group represent, for example, transmitters using the same chipset. The sample transmitters represent transmitters selected among the transmitters of the same group so as to extract gain combination information common to the transmitters of the same group. In one embodiment, the common gain combination information extracted from the sample transmitters is applied to all the transmitters of the same group in the transmitter producing process.

The general gain combination represents information determined in a process of designing a chipset of a transmitter. The general gain combination information may be stored at a storage apparatus. And a computer apparatus which determines output value compensation parameter could receive the general gain combination information from the storage apparatus. However, output values of individual transmitters differ depending on the general gain combination. In this regard, according to the example, common gain combination information is generated by reflecting output value compensation parameters of sample transmitters on the general gain combination.

According to the method of generating a gain combination of a pre-amplifier in a transmitter of a mobile communication system (100), first, general combination information needs to be collected with respect to transmitters of the same group (110). Since the general gain combination information may differ depending on the chipset, and is determined in a process of designing the chipset, the general gain combination information is easily collected.

Output values of the selected respective sample transmitters are measured by use of the general gain combination information (120). In consideration of the output values for the respective sample transmitters, output value compensation parameters are determined (130). An average of the output value compensation parameters of the respective sample transmitters is calculated, and final common gain combination information is generated by reflecting the average output value compensation parameter on the general gain combination information (140).

When the factory calibration is performed based on temperature characteristics of transmitters in a communication system, the required time cost may be enormous, and the implementation thereof is very difficult. According to one example, common characteristics at each level of temperature of the sample transmitters are extracted, thereby obtaining information about the degree of gain change in each amplifier stage according to the temperature. For example, in a process of extracting common gain combination information, characteristic information according to temperature may be extracted to be incorporated in the common gain combination information, or stored as additional information in the transmitter. As such, the gain change according to the temperature is stored in the transmitter, so that the maximum output power and the output power stage are easily calibrated.

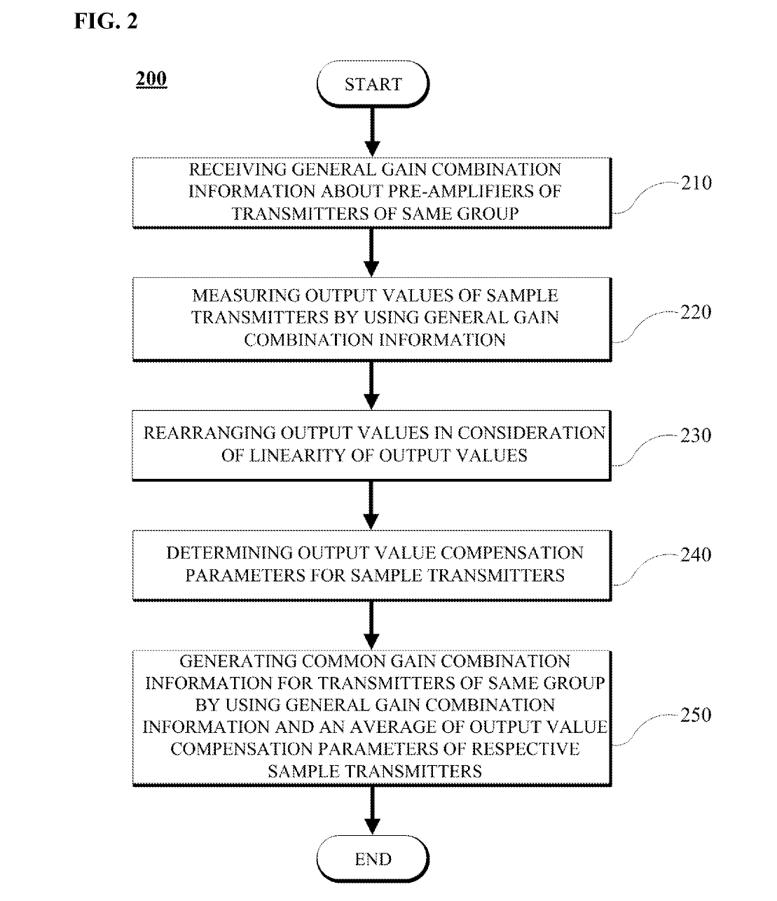

FIG. 2 is a flowchart illustrating another example of a method of generating a gain combination of pre-amplifiers for a transmitter of a mobile communication system (200).

The method of generating a gain combination of a pre-amplifier in a transmitter of a mobile communication system (200) includes receiving general gain combination information about pre-amplifiers of transmitters of the same group (210), measuring output values of pre-amplifiers of sample transmitters by use of the general gain combination information (220), rearranging unnecessary output values of the sample transmitters in consideration of linearity of the output values (230), determining output value compensation parameters for the sample transmitters (240), and generating common gain combination information for the transmitters of the same group by use of the general gain combination information and an average of the output value compensation parameters of the respective sample transmitters (250).

Different from the method (100) of generating the gain combination described with reference to FIG. 1, the method (200) includes a process of removing unnecessary or erroneous information in consideration of linearity of the output values.

The rearranging of the output values (230) includes rearranging output powers in consideration of non-uniformity characteristics between the pre-amplifiers in the sample transmitters, and inserting fine gain combination information. In this process, the common gain combination information extracted from the sample transmitters is compensated.

The gain combination information is used to control output powers for transmitters in consideration of noise characteristics and linearity of a transmitter of the mobile communication system.

As described above, the gain combination information may include information about a gain change according to temperature of the pre-amplifier.

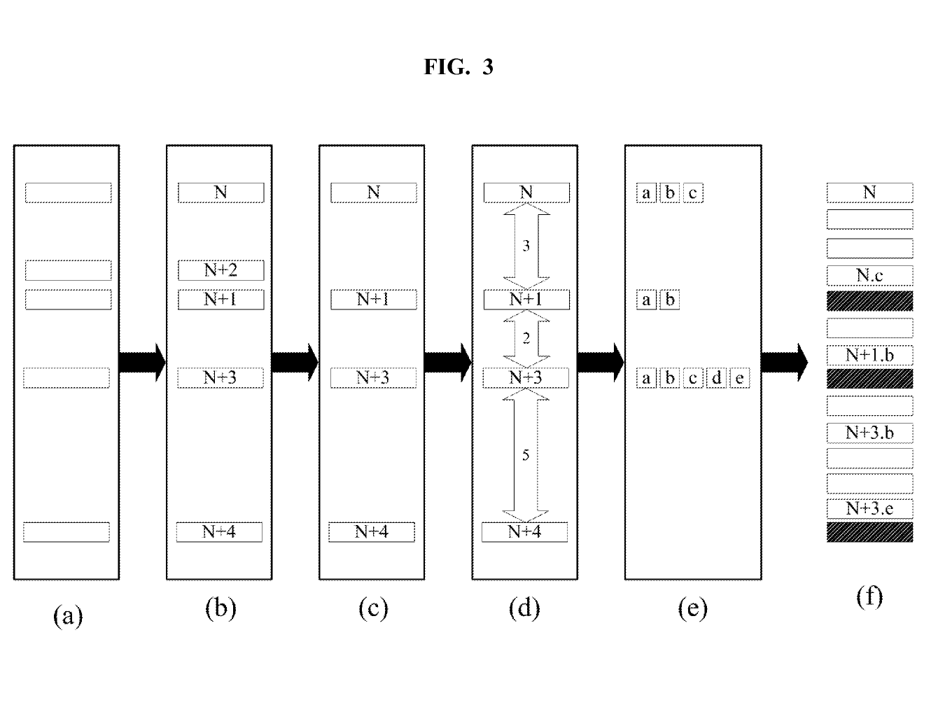

FIG. 3 is a diagram illustrating an example of a process of generating common gain combination information according to a gain combination extraction method shown in FIG. 2. Referring to FIG. 3, (a) represents general gain combination information about transmitters of the same group. Process (b) represents a result obtained by measuring output values of sample transmitters among the transmitters of the same group. As shown in process (b), the output values are arranged in the order of N→N+2→N+1. In this case, “N+2” is obtained due to non-uniformity characteristics of an individual transmitter, and thus deleted during the rearrangement process (230). Process (c) represents rearranged output values of the sample transmitters.

A difference between output values of adjacent pieces of gain combination information is measured in the rearrangement process (230) of FIG. 2 or process (b) of FIG. 3, and an inverse parameter with respect to the gain combination is extracted to be used for rearrangement.

Process (d) of FIG. 3 shows a result obtained by measuring a difference between output values with respect to adjacent pieces of gain combination information after the rearrangement of output values. For example, N is spaced apart from N+1 by 3. Process (e) represents extracting output value compensation parameters, and process (f) represents extracting final common gain combination information by reflecting the output value compensation parameters on the general gain combination information.

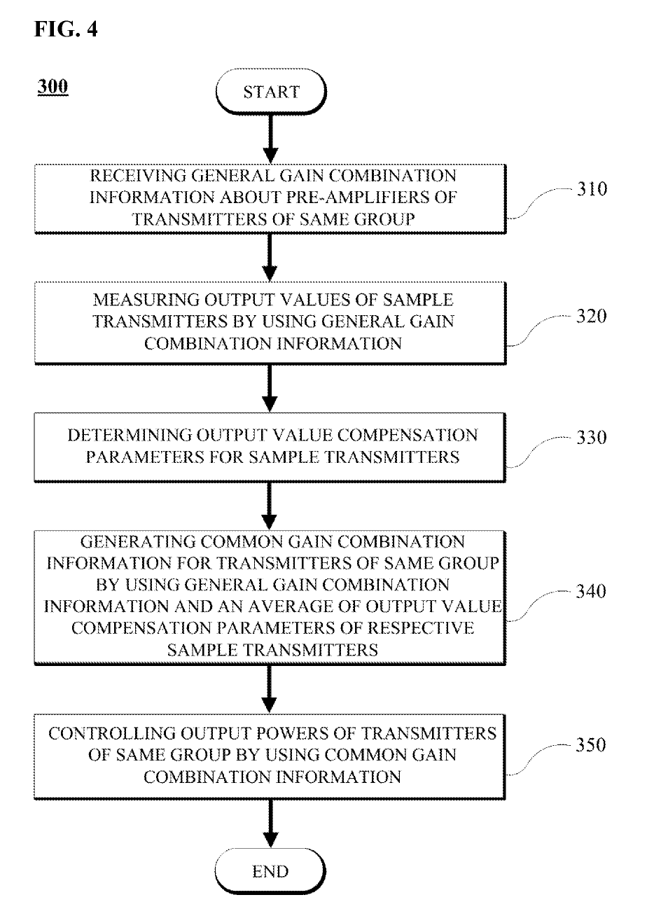

FIG. 4 is a flowchart illustrating an example of a method of controlling an output power of a transmitter in a process of manufacturing a transmitter of a mobile communication system (300). The method of controlling the output power (300) represent an exemplary method of controlling the output power in a process of manufacturing a transmitter, by use of the gain combination extracting method (200) described above with reference to FIG. 2.

The method of controlling an output power of a transmitter in a process of manufacturing a transmitter of a mobile communication system (300) includes extracting respective pieces of general gain combination information about pre-amplifiers in a plurality of sample transmitters among transmitters of the same group (310), measuring output values of the respective sample transmitters by use of the general gain combination information (320), determining output value compensation parameters for the respective sample transmitters (330), generating common gain combination information for the transmitters of the same group by use of the general gain combination information and an average of the output value compensation parameters of the respective sample transmitters (340), and controlling output powers of the transmitters of the same group by use of the common gain combination information (350).

The process of extracting the common gain combination information shown in FIG. 4 corresponds to the process of generating the common gain combination information shown in FIG. 2. In one embodiment, the method of controlling output powers in a process of manufacturing a transmitter of a mobile communication system (300) includes performing a calibration of collectively controlling output powers of all the transmitters belonging to the same group by use of the finally calculated common gain combination information (350).

In one embodiment, controlling the output powers is performed by applying the common gain combination information to a pre-amplifier in the transmitter of the same group.

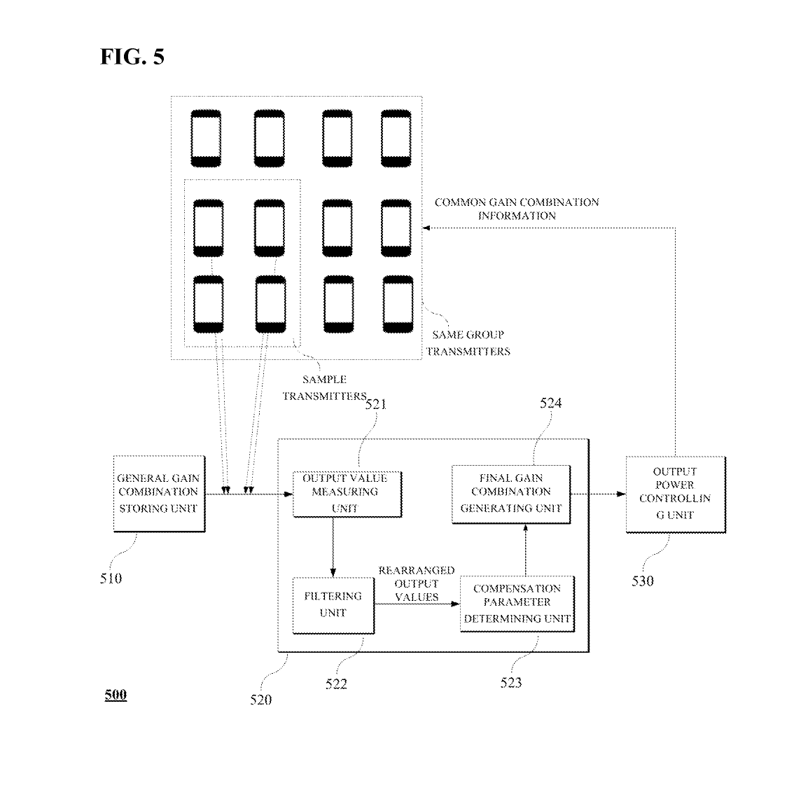

FIG. 5 is a block diagram illustrating an example of a configuration of a system for controlling an output power in a process of manufacturing a transmitter of a mobile communication system.

In one embodiment, the system 500 for controlling an output power in a process of manufacturing a transmitter of a mobile communication system is implemented by using the method (300) of controlling output powers in a process of manufacturing a transmitter of a mobile communication system of FIG. 4. In the process of manufacturing the transmitter, common gain combination information is extracted through a computer device, and based on the common gain combination information, an output value calibration apparatus is driven.

The system 500 for controlling an output power in a process of manufacturing a transmitter of a mobile communication system includes a general gain combination storing unit 510 configured to store general gain combination information about transmitters of the same group in consideration of noise characteristics and linearity of a transmitter of the mobile communication system, a common gain combination generator 520 configured to generate common gain combination information for a plurality of sample transmitters among the transmitters of the same group by use of the general gain combination information, and an output power controlling unit 530 configured to control output powers of the transmitters of the same group by use of the common gain combination information. The various units described herein may be implemented and configured using various known components, such as processors, memory, other circuitry elements, and/or software components. These components may be combined in a configuration that performs the various steps and processes described herein. Although blocks of FIG. 5 are illustrated as being separated according to the functions thereof, the respective blocks may use a single processor and a single memory in common.

The general gain combination storing unit 510 stores gain combination information about a chipset used in transmitters of the same group.

The common gain combination generator 520 includes an output value measuring unit 521 configured to measure output values of the respective sample transmitters by use of the general gain combination information, a filtering unit 522 configured to rearrange the output values of the sample transmitters by use of linearity of the output values, a compensation parameter determining unit 523 configured to determine output value compensation parameters for the respective sample transmitters by use of a difference between the rearranged output values, and a final gain combination generating unit 524 configured to generate common gain combination information for the transmitters of the same group by use of the general gain combination information and an average of the output value compensation parameters of the respective sample transmitters.

The output value measuring unit 521 measures values that are output from sample transmitters by applying the general gain combination information stored in the general gain combination storing unit 510 to the sample transmitters.

The filtering unit 522 rearranges the output values by deleting a value that is deviated from linearity among the output values of the sample transmitters.

The compensation parameter determining unit 523 determines output value compensation parameters for the respective sample transmitters that are used to adjust the output values different from the general gain combination information.

The final gain combination generating unit 524 obtains an average of the output value compensation parameters for the respective sample transmitters, and applies the average to the general gain combination information. Accordingly, the final common gain combination information is generated.

The output power controlling unit 530 represents an output value calibration apparatus configured to receive the common gain combination information.

In a real production process, the common gain combination information generated through the computer device may be used by the conventional factory calibration apparatus. However, different from the conventional factory calibration apparatus that is configured to individually process each transmitter, in certain disclosed embodiments, the output power controlling unit 530 collectively controls the output powers of the transmitters of the same group by use of the common gain combination information.

The gain combination information according to certain examples may include information about a gain change according to temperatures, and as the gain change according to the temperatures is input in the transmitter, the transmit power can be accurately controlled according to the temperatures. In addition, the common gain combination information extracted according to the examples may be applied only to transmitters of a certain same group. Accordingly, the common gain combination information may be used as information for identifying transmitters belonging to the same group. As the common gain combination information is used as an additional identifier for identifying a transmitter in the producing process, the efficiency in production management may be enhanced.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of generating a gain combination for a pre-amplifier in a transmitter of a mobile communication system, the method comprising:
receiving, at a computer apparatus, general gain combination information about pre-amplifiers of transmitters of a same group from a storage apparatus having the general gain combination information;
determining, at the computer apparatus, output value compensation parameters by applying the general gain combination information to each of a plurality of sample transmitters among the transmitters of the same group; and
generating, at the computer apparatus, common gain combination information for the transmitters of the same group by use of the general gain combination information and an average of the output value compensation parameters of the respective sample transmitters.

2. The method of claim 1, wherein the determining of the output value compensation parameters includes:
measuring output values of pre-amplifiers of the sample transmitters by use of the general gain combination information;
rearranging the output values of the sample transmitters in consideration of linearity of the output values; and
determining the output value compensation parameters for the sample transmitters.

3. The method of claim 2, wherein the rearranging of the output values of the sample transmitters includes rearranging output powers in consideration of non-uniformity characteristics between the pre-amplifiers in each of the sample transmitters, and inserting fine gain combination information.

4. The method of claim 1, wherein the gain combination information is a gain combination configured to control output powers for the transmitters in consideration of noise characteristics and linearity of a transmitter of the mobile communication system.

5. The method of claim 1, wherein the gain combination information includes gain change information according to temperature of the pre-amplifier.

6. A method of controlling an output power in a process of manufacturing a transmitter of a mobile communication system, the method comprising:
generating common gain combination information for a plurality of sample transmitters among transmitters of a same group by use of general gain combination information about the transmitters of the same group; and
applying the common gain combination information to a pre-amplifier in the transmitter of the same group.

7. The method of claim 6, wherein the gain combination information is a gain combination configured to control output powers of the transmitters in consideration of noise characteristics and linearity of a transmitter of the mobile communication system.

8. The method of claim 6, wherein the generating of the common gain combination information includes:
receiving general gain combination information about pre-amplifiers of transmitters of a same group;
determining an output value compensation parameter for each of the plurality of sample transmitters by use of the general gain combination information; and
generating common gain combination information for the transmitters of the same group by use of the general gain combination information and an average of the output value compensation parameters of the sample transmitters.

9. The method of claim 8, wherein the determining of the output value compensation parameter includes:
measuring output values of the sample transmitters by use of the general gain combination information;
rearranging the output values by deleting information that does not conform to linearity of the output values of the sample transmitter; and
determining output value compensation parameters for the rearranged output values.

10. The method of claim 9, wherein the rearranging of the output values of the sample transmitters includes rearranging output powers in consideration of non-uniformity characteristics between the pre-amplifiers in each of the sample transmitters, and inserting fine gain combination information.

11. The method of claim 6, wherein the gain combination information includes gain change information according to temperature of the pre-amplifier.

12. A system for controlling an output power in a process of manufacturing a transmitter of a mobile communication system, the system comprising:
a general gain combination storing unit configured to store general gain combination information about transmitters of a same group in consideration of noise characteristics and linearity of a transmitter of the mobile communication system;
a common gain combination generator configured to generate common gain combination information for a plurality of sample transmitters among the transmitters of the same group by use of the general gain combination information; and
an output power controlling unit configured to apply the common gain combination information to a pre-amplifier in the transmitter of the same group.

13. The system of claim 12, wherein the common gain combination generator includes:
an output value measuring unit configured to measure an output value of each of the sample transmitters by use of the general gain combination information;
a filtering unit configured to rearrange the output values of the sample transmitters by use of linearity of the output values;
a compensation parameter determining unit configured to determine an output value compensation parameter for each of the sample transmitters by use of a difference between the rearranged output values; and
a final gain combination generating unit configured to generate common gain combination information for the transmitters of the same group by use of the general gain combination information and an average of the output value compensation parameters of the sample transmitters.

14. The system of claim 13, wherein the filtering unit rearranges the output values by rearranging output powers in consideration of non-uniformity characteristics between pre-amplifiers in each of the sample transmitters, and inserting fine gain combination information.
